(19) United States
(12) Patent Application Publication
(10) Pub. No.: US 2013/0132980 A1
(43) Pub. Date: May 23, 2013

(54) DISC LOADING DEVICE AND OPTICAL DISC DRIVE INCLUDING THE SAME

(71) Applicants: Un-jin Choi, Suwon-si (KR); Joung-sug Ko, Seoul (KR); Sang-yun Baek, Seongnam-si (KR); Cheol-woong Ahn, Seoul (KR)

(72) Inventors: Un-jin Choi, Suwon-si (KR); Joung-sug Ko, Seoul (KR); Sang-yun Baek, Seongnam-si (KR); Cheol-woong Ahn, Seoul (KR)

(21) Appl. No.: 13/670,645

(22) Filed: Nov. 7, 2012

(30) Foreign Application Priority Data
Nov. 23, 2011 (KR) 10-2011-0123126

(51) Int. Cl. G11B 17/051

(52) U.S. Cl. 720/624; G9B/17.032

(57) ABSTRACT

Provided are a disc loading device and an optical disc drive using the same. When a disc is loaded into the optical disc drive, an eject lever and a main slider may be used to facilitate an open/close operation of a door of the optical disc drive. In addition, by shutting off power to a loading roller after loading a disc, the disc is prevented from being damaged by the loading roller while the disc is being chucked.

### CROSS-REFERENCE TO RELATED APPLICATION(S)

This application claims the benefit under 35 USC §119(a) of Korean Patent Application No. 10-2011-0123126, filed on Nov. 23, 2011, in the Korean Intellectual Property Office, the entire disclosure of which is incorporated herein by reference for all purposes.

### BACKGROUND

1. Field

The following description relates to a disc loading device and an optical disc drive using the disc loading device, for example, to a roller and slot-in type disc loading device.

2. Description of Related Art

An optical disc drive may be classified into a tray-type device and a slot-in type device based on a disc loading structure of the optical disc drive. A slot-in type disc drive is further classified into a lever type and a roller-type based on a structure used to hold a disc.

In a roller-type disc loading device, a disc is loaded into an optical disc drive and then the disc is chucked on a spindle. A slot into which the disc is inserted may be formed in a front panel. External impurities such as dust may be introduced to an optical disc drive through the slot. For example, when a disc is rotated at a high speed, a large amount of external dust may be introduced through the slot. Accordingly, it is preferably to close the slot prior to an operation of the disc.

In a structure in which loading and chucking of a disc are performed via a single motor, idling of a loading roller is typically performed until the disc is moved to a chucking position and then is completely chucked. In this case, the loading roller applies friction to a surface of the disc. The friction may cause the disc to be scratched. Thus, there is a need for a structure for opening and closing a slot and preventing idling of the loading roller in order to prevent the inside of an optical disc drive from being contaminated and from scratching an optical disc.

### SUMMARY

In an aspect, there is provided a disc loading device including a main frame coupled to a front panel in which a slot is formed, wherein a disc is inserted into the slot, a loading roller configured to load the disc into the main frame, an eject lever configured to eject the disc, a rotational door configured to open and close the slot, a main slider configured to operate the eject lever and the rotational door, and a loading motor for driving the loading roller and the main slider.

The rotational door may comprise a body for opening and closing the slot, hinge portions positioned at opposite end portions of the body and rotatably supporting the body against the main frame, and a pressurizing portion that is disposed at one side of the body and which interferes with the main slider to perform open and close operations of the body.

The front panel may be disposed to face a front end portion of the main slider, and an emergency eject hole through which an emergency eject pin passes may be installed in the front panel to pressurize the front end portion of the main slider.

The front end portion of the main slider may operate the rotational door to open and close the slot.

The disc loading device may further comprise a power train system comprising a plurality of gears disposed between the loading motor and the loading roller.

The disc loading device may further comprise a power controlling device installed in the power train system and managing a power transferring path toward the loading roller.

The power controlling device may comprise a clutch gear disposed between gears of the power train system, and a clutch lever for operating the clutch gear in synchronization with loading of the disc to block a power transferring path between the gears.

In response to the disc being loaded into the disc loading device, the rotational door may rotate to cover the slot such that an interior of the disc loading device is not exposed to external elements.

In an aspect, there is provided a disc loading device including a main frame coupled to a front panel in which a slot is formed, wherein a disc is inserted into the slot, an optical pickup assembly disposed in the main frame and comprising a spindle on which a disc is mounted and an optical pickup module to read data from the disc, a loading roller configured to load the disc into the main frame, an eject lever configured to eject the disc, a main slider configured to operate the eject lever, and a loading motor configured to drive the loading roller and the main slider.

The disc loading device may further comprise a rotational door which comprises a body for opening and closing the slot, hinge portions positioned at opposite end portions of the body and rotatably supporting the body against the main frame, and a pressurizing portion that is disposed at one side of the body and which interferes with the main slider to perform open and close operations of the body.

A front end portion of the main slider may face the front panel, and an emergency eject hole through which an emergency eject pin passes may be installed in the front panel to pressurize the main slider.

The front end portion of the main slider may operate the rotational door to open and close the slot.

The disc loading device may further comprise a power train system comprising a plurality of gears disposed between the loading motor and the loading roller.

The disc loading device may further comprise a power controlling device installed in the power train system and managing a power transferring path toward the loading roller.

The power controlling device may comprise a clutch gear disposed between gears of the power train system, and a clutch lever for operating the clutch gear in synchronization with loading of the disc to block a power transferring path between the gears.

In response to the disc being loaded into the disc loading device, the rotational door may rotate to cover the slot such that an interior of the disc loading device is not exposed to external elements.

Other features and aspects may be apparent from the following detailed description, the drawings, and the claims.

### BRIEF DESCRIPTION OF THE DRAWINGS

FIGS. 1A and 1B are diagrams illustrating examples of an internal structure of a slot-in type optical disc drive.

FIG. 2 is a diagram illustrating an example of a power train system for transferring power.

FIG. 3 is a diagram illustrating an example of a power train system of a slot-in type optical disc drive.

FIG. 4 is a diagram illustrating an example of a power controlling structure of a slot-in type optical disc drive.

FIGS. 5 through 7 are diagrams illustrating examples of an operation of a power controlling device in a disc loading process and a disc chucking process in a slot-in type optical disc drive.

FIGS. 8 and 9 are diagrams illustrating examples of an operation of a door via a main slider in an optical disc drive.

FIG. 10 is a diagram illustrating an example in which a disc is ejected when a main slider is pushed by an emergency (manual) eject pin.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

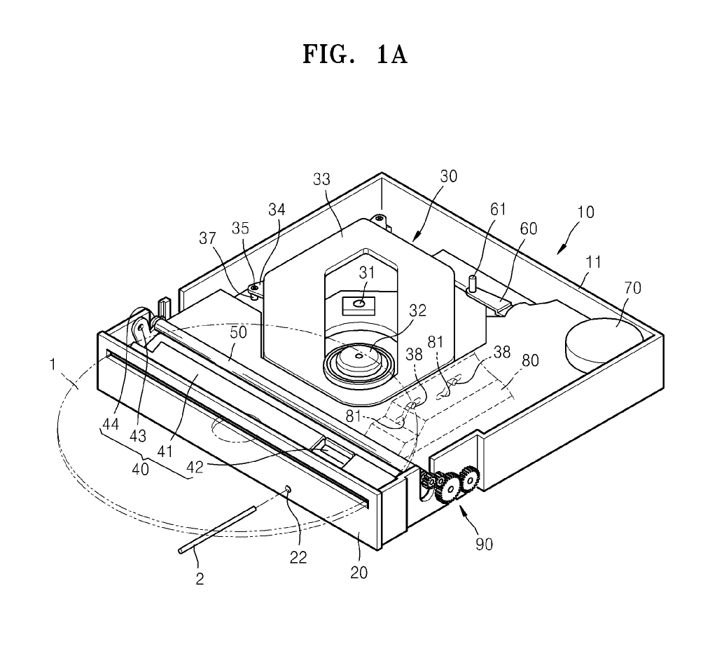

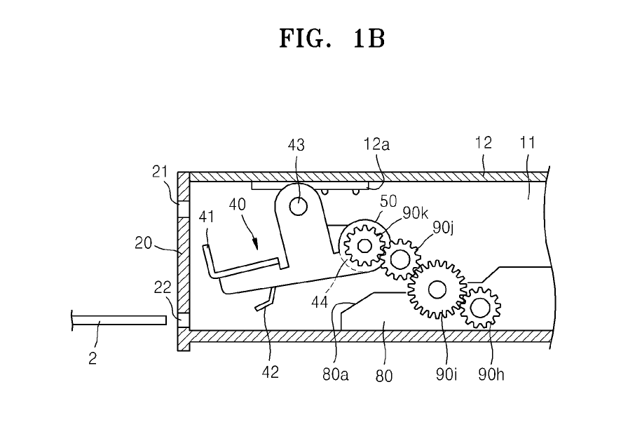

FIG. 1A illustrates an example of an internal structure of a slot-in type optical disc drive 10 using a disc loading device. FIG. 1B illustrates an example of a power train system for a door around a front panel of the slot-in type optical disc drive 10.

Referring to FIGS. 1A and 1B, a front panel 20 includes a slot 21 for inserting or ejecting a disc 1 therethrough. The front panel 20 is positioned in front of a main frame 11. An emergency eject hole 22 through which an emergency eject pin 2 passes is formed in the front panel 20. The emergency eject pin 2 may compulsorily eject the disc 1 via an eject lever 60 by compulsorily pushing a main slider 80. The emergency eject pin 2 pushes a front end portion 80a of the main slider 80 such that the eject lever 60 linked with the main slider 80 may rotate to compulsorily eject the disc 1. The eject lever 60 may be rotatably installed in a rear portion of the main frame 11 and may have a disc pusher 61 that contacts the disc 1.

A rotational door 40 and a loading roller 50 are installed behind the front panel 20. The rotational door 40 and the loading roller 50 are used to open and close the slot 21. In this example, the rotational door 40 includes a body 41 that is operated by the main slider 80 and opens and closes the slot 21, a pressurizing portion 42 that is disposed at one side of the body 41 and rotates the body 41 while being pushed by the front end portion 80a of the main slider 80, and hinge portions 43 positioned at opposite end portions of the body 41.

Loading roller rotation supporters 44 for rotatably supporting opposite end portions of the loading roller 50 are disposed near the two hinge portions 43 of the rotational door 40. Thus, when the rotational door 40 rotates around the hinge portions 43, the loading roller 50 that is coupled to the rotational door 40 moves along with the rotational door 40. A loading gear 90k is coupled to one end portion of the loading roller 50 and is coupled to and decoupled from a seventh gear 90j. The loading roller 50 is disposed on an inner surface of a top cover 12 installed on the main frame 11 and may move the disc 1 while pressurizing the disc 1 against a disc supporting member 12a for supporting an upper surface of the disc 1. The power train system 90 includes fifth and sixth gears 90h and 90i for transferring power to the seventh gear 90j.

An optical pickup assembly 30 is disposed on a central portion of the main frame 11. The optical pickup assembly 30 includes a spindle 32, an optical pickup module 31, and a sub frame 33 for supporting the spindle 32 and the optical pickup module 31. The optical pickup assembly 30 may be rotated by the main slider 80 which is further described below such that the optical pickup module 31 and the spindle 32 may approach the disc 1 or may be decoupled from the disc 1.

A plurality of fixing wings 34 (two fixing wings 34 in the present example) are formed on the sub frame 33. The plurality of fixing wings 34 are fixed by screws 35 and the like. The plurality of fixing wings 34 may use a medium such as spacers 37 formed of an elastic material, for example, rubber or sponge. In addition, a first guide pin 38 is inserted into a first cam groove 81 and is disposed on a lateral surface of the main slider 80 and is close to the spindle 32 on the sub frame 33. The first guide pin 38 ascends and descends in response to a reciprocating motion of the main slider 80 to lift up or down the spindle 32 and the optical pickup module 31.

A loading motor 70 is disposed on a corner portion of the main frame 11, which is adjacent to the eject lever 60. The loading motor 70 may operate the optical pickup assembly 30, the rotational door 40, the loading roller 50, the eject lever 60, the main slider 80, and the like, via the power train system 90 including a plurality of gears.

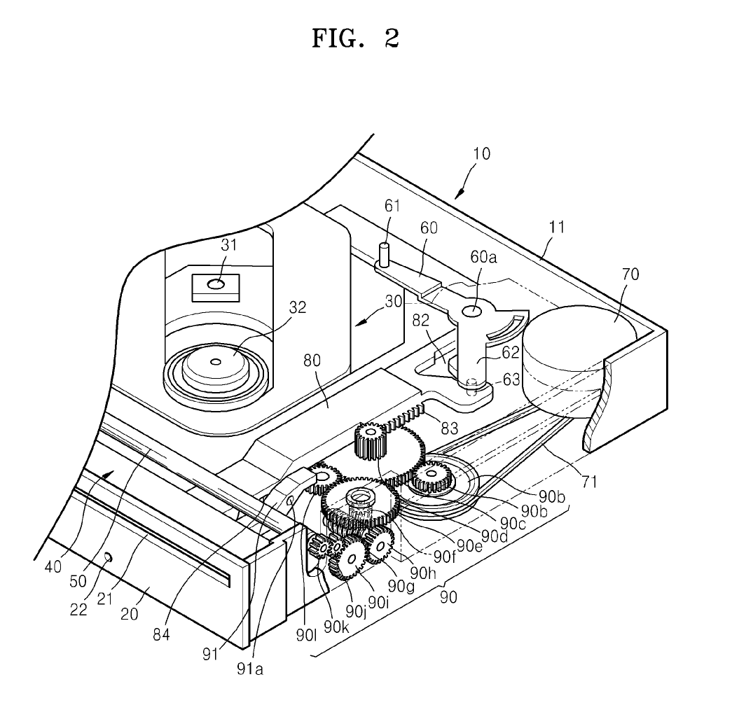

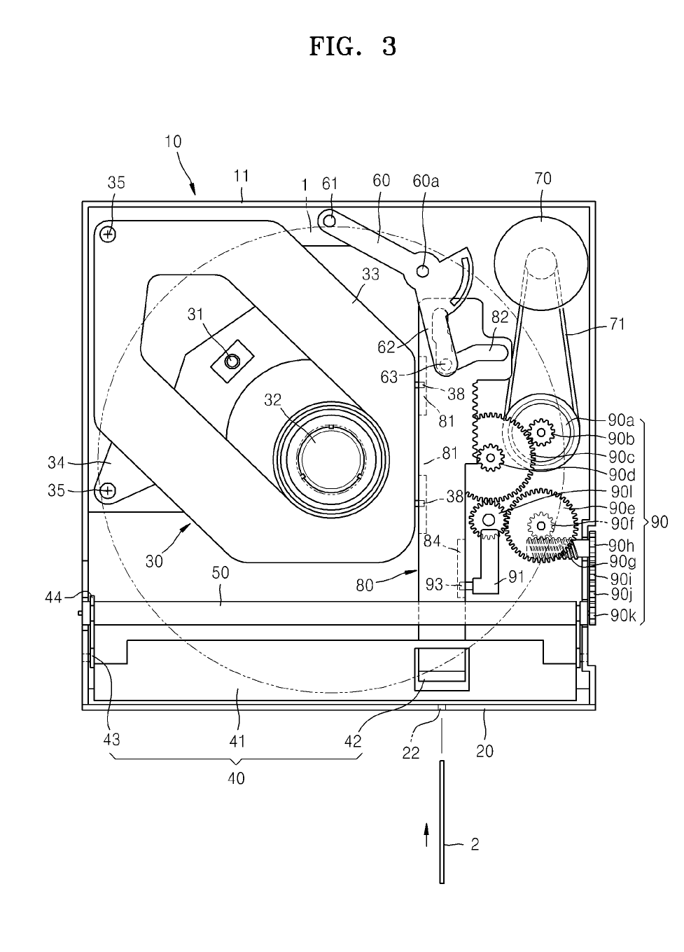

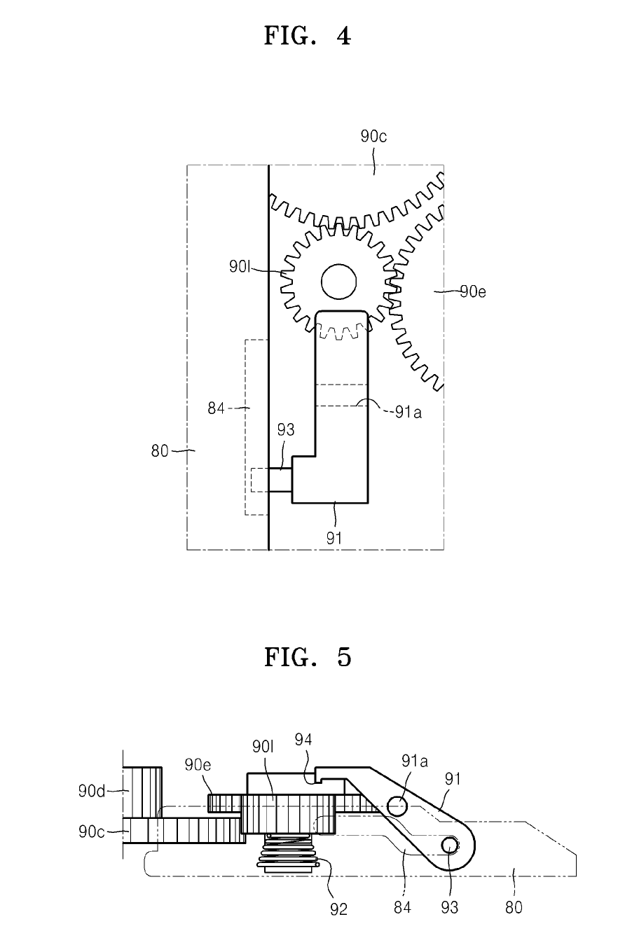

FIG. 2 illustrates an example of the power train system 90 for transferring power from the loading motor 70 to the main slider 80, the loading roller 50, and the like. FIG. 3 illustrates an example of a schematic layout of the power train system 90. FIG. 4 illustrates an example of a power controlling structure using a clutch gear 90l.

Referring to FIGS. 2 and 3, the loading motor 70 is connected to a pulley 90a via a belt 71, and thus, the pulley 90a is rotated by the loading motor 70. A first gear 90b is coaxially integrated with the pulley 90a. In this example, the first gear 90b is engaged with a second gear 90c that is coaxially integrated with a third gear 90d that is engaged with a rack gear 83 formed on the main slider 80. Accordingly, the main slider 80 reciprocates by a predetermined distance according to rotation of the loading motor 70.

A fourth gear 90e is disposed adjacent to the second gear 90c. The clutch gear 90l is disposed between the fourth gear 90e and the second gear 90c. The clutch gear 90l is operated by a clutch lever 91 and controls power between the second gear 90c and the fourth gear 90e. The clutch gear 90l is installed to elastically descend in an axial direction. Thus, in a normal state, the clutch gear 90l is engaged with both the second gear 90c and a fourth gear 90f. In addition, when the operated clutch lever 91 pushes the clutch gear 90l, the clutch gear 90l becomes decoupled from the fourth gear 90e. In this example, the clutch lever 91 rotates around a rotation axis 91a.

A pressurizing portion 94 contacts the clutch gear 90l and is disposed on a front end portion of the clutch lever 91. In addition, a third guide pin 93 is disposed on a rear end portion of the clutch lever 91 and is disposed in a third cam groove 84 formed in a lateral surface of the main slider 80. A worm wheel 90f is disposed below the fourth gear 90e that receives power from the clutch gear 90l. A worm shaft 90g that is engaged with the worm wheel 90f is disposed next to the worm wheel 90f. The worm wheel 90f and the worm shaft 90g may change a movement direction or a rotation direction. According to various aspects, a rotation axis of the worm wheel 90f is directed to a vertical direction and a rotation axis of the worm shaft 90g is directed to a horizontal direction.

The fifth gear 90h is coaxially coupled to the worm shaft 90g. Power is transferred from the fifth gear 90h to the loading gear 90k through six and seventh gears 90i and 90j. In this example, the loading gear 90k is coaxially coupled to the loading roller 50 so as to load and unload the disc 1 via the loading roller 50.

A second cam groove 82 for operating the eject lever 60 is formed in the main slider 80 that is reciprocated by the third gear 90d. A second guide pin 63 is formed on an operating lever 62 integrated with the eject lever 60 and is disposed in the second cam groove 82. Thus, when the main slider 80 reciprocates, the second guide pin 63 disposed in the second cam groove 82 moves along the second cam groove 82, and the operating lever 62 and the eject lever 60 integrated therewith rotate.

The first cam groove 81 is formed in a lateral surface of the main slider 80 adjacent to the optical pickup assembly 30, and the first guide pin 38 is inserted into the first cam groove 81 and is formed in a lateral surface of the optical pickup assembly 30. In this example, the optical pickup assembly 30 faces the lateral surface of the main slider 80. The main slider 80 begins to operate (move) while the disc 1 reaches a chucking position and the third gear 90d and the rack gear 83 are engaged with each other. While the main slider 80 moves, the first cam groove 81 lifts the first guide pin 38 and the optical pickup assembly 30 approaches the disc 1 such that the disc 1 is chucked on the spindle 32.

The front end portion 80a of the main slider 80 is positioned adjacent to the emergency eject hole 22 formed through the emergency eject pin 2. As shown in FIG. 3, when the disc 1 is completely inserted, the rack gear 83 of the main slider 80 is engaged with the third gear 90d which functions as a pinion gear. In this state, when the main slider 80 is moved back by the emergency eject pin 2, the rack gear 83 deviates from the pinion gear 90d. In this example, when the main slider 80 is not secured by the pinion gear 90d, the main slider 80 may be further moved back. The main slider 80 moves back to rotate the eject lever 60. According to various aspects, the eject lever 60 may rotate counterclockwise so as to compulsorily eject the disc 1.

FIGS. 5 through 7 illustrate examples of positional changes and power controlling states of the clutch lever 91 operated by the main slider 80 and the clutch gear 90l operated by the clutch lever 91.

FIG. 5 illustrates an example of a state where a front end portion of the clutch lever 91, that is, the pressurizing portion 94 is lifted such that the clutch gear 90l is elastically biased by a spring 92 to be engaged with both the second gear 90c and the fourth gear 90e. This state is an initial state in which the disc 1 begins to load.

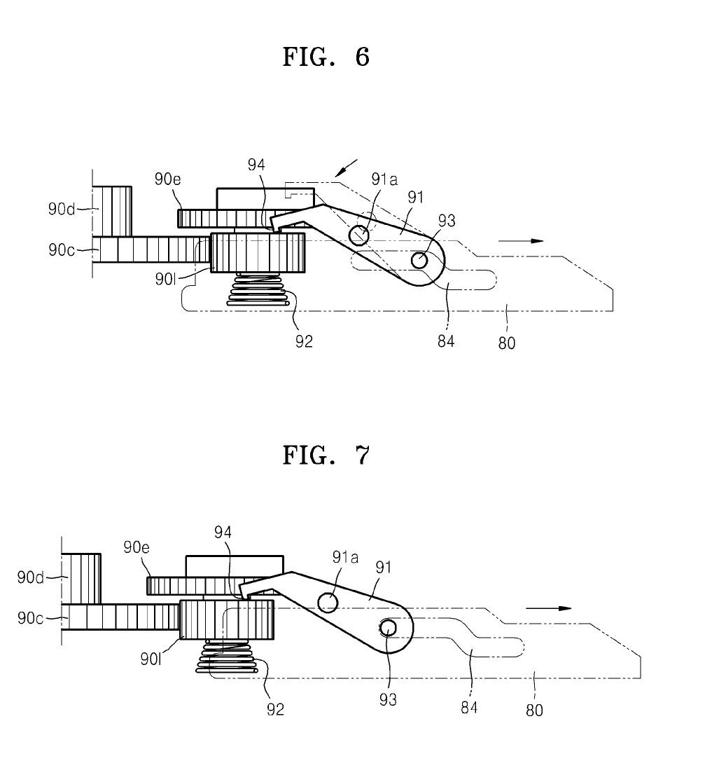

FIG. 6 illustrates an example of a state in which the main slider 80 is moved to completely load the disc 1. In this example, the disc 1 is completely inserted into the main frame 11 so as to be chucked on a spindle. In this state, the third guide pin 93 is lifted by the third cam groove 84 of the main slider 80 so as to rotate the clutch lever 91. The pressurizing portion 94 of the rotated clutch lever 91 pushes the clutch gear 90l to deviate the clutch gear 90l from the fourth gear 90e. Thus, the fourth gear 90e stops rotating such that the loading roller 50 for transferring power via the fourth gear 90e may stop rotating.

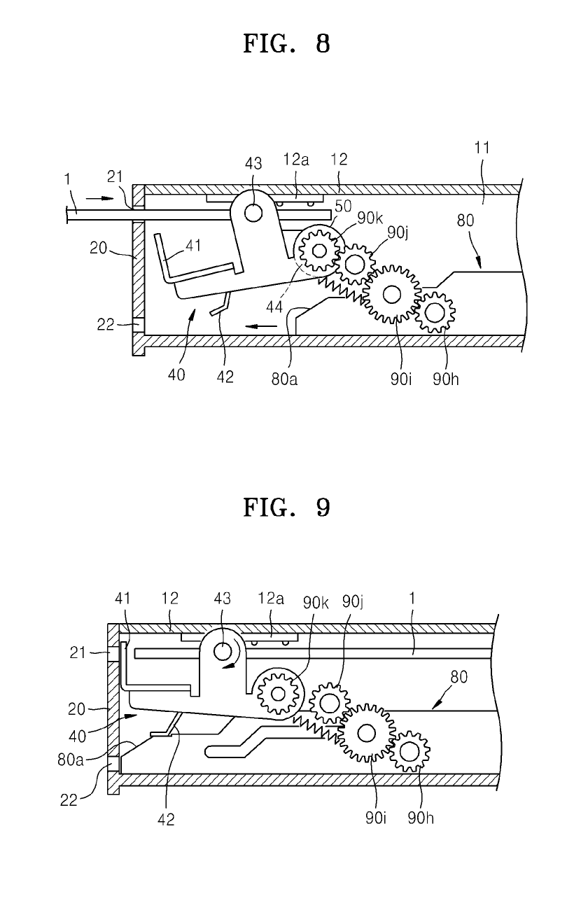

While the disc 1 is being chucked, the loading roller 50 does not rotate, and thus, friction between the disc 1 and the loading roller 50 is not generated. When the loading roller 50 stops rotating, the rack gear 83 of the main slider 80 and the third gear 90d are engaged with each other. In this example, the main slider 80 continues to rotate such that the main slider 80 begins to move. Thus, the optical pickup assembly 30 ascends and descends via the first cam groove 81 (see FIG. 1A) of the main slider 80 to enter a state shown in FIG. 8.

When the main slider 80 enters a chucking completion position, the loading motor 70 may stop being driven via a position detecting switch (not shown) for detecting a position of the main slider 80.

FIGS. 8 and 9 illustrate examples of an operation of the rotational door 40 via the main slider 80. FIG. 8 shows a process of loading the disc 1 and FIG. 9 shows a state in which the disc 1 is completely loaded.

Referring to FIG. 8, when the main slider 80 moves back, the rotational door 40 does not cover the slot 21 and the loading gear 90k is not engaged with the seventh gear 90j. Referring to FIG. 9, when the main slider 80 moves forward (in a left direction in FIG. 9), the rotational door 40 is operated by the main slider 80 such that the body 41 covers the slot 21. As shown in FIG. 9, the rotational door 40 is operated by the main slider 80 such that the loading gear 90k may be coupled to or decoupled from the seventh gear 90j. The disc 1 is loaded and the loading gear 90k is decoupled from the seventh gear 90j such that the loading roller 50 is not secured by the power train system 90. In addition, the front end portion 80a of the main slider 80 is positioned adjacent to the emergency eject hole 22. In this example, the rotational door 40 is rotated such that the body 41 of the rotational door covers the slot 21 to prevent impurities from being introduced into the disc drive.

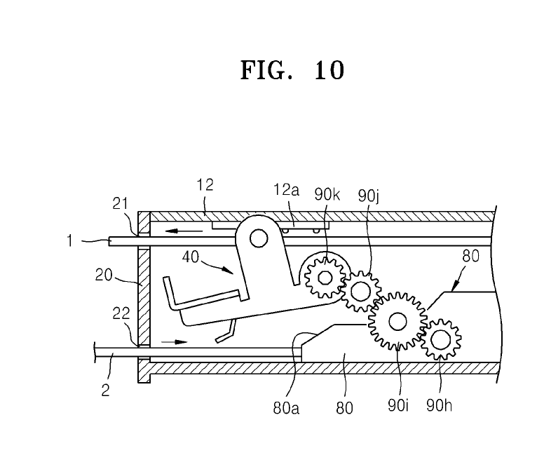

FIG. 10 illustrates an example of a state in which the disc 1 is manually ejected. Referring to FIG. 10, when the emergency eject pin 2 is compulsorily pushed into the emergency eject hole 22, the emergency eject pin 2 presses the front end portion 80a of the main slider 80 adjacent to the emergency eject hole 22. As a result, the main slider 80 moves back and an eject lever is operated so as to eject the disc 1.

According to various aspects, an optical disc driving including the above-described structure is configured such that a door is operated by a main slider without using a separate component. In this example, an eject lever and a main slider may be used to facilitate an open/close operation of the door of the optical disc unit. In addition, by shutting off power to a loading roller after loading a disc, the disc is prevented from being damaged due to the loading roller while the disc is being chucked.

According to various aspects, a roller loading-type disc loading device is configured such that a door is opened and closed by a main slider for driving an eject lever. The door prevents impurities from penetrating into the disc loading device by opening and closing a slot that is normally opened. In addition, the door that is operated by the main slider closes the slot prior to an operation of a spindle device so as to protect an internal portion of the loading device from external impurities.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A disc loading device comprising:
a main frame coupled to a front panel in which a slot is formed, wherein a disc is inserted into the slot;
a loading roller configured to load the disc into the main frame;
an eject lever configured to eject the disc;
a rotational door configured to open and close the slot;
a main slider configured to operate the eject lever and the rotational door; and
a loading motor for driving the loading roller and the main slider.

2. The disc loading device of claim 1, wherein the rotational door comprises:
a body for opening and closing the slot;
hinge portions positioned at opposite end portions of the body and rotatably supporting the body against the main frame; and
a pressurizing portion that is disposed at one side of the body and which interferes with the main slider to perform open and close operations of the body.

3. The disc loading device of claim 1, wherein the front panel is disposed to face a front end portion of the main slider, and
an emergency eject hole through which an emergency eject pin passes is installed in the front panel to pressurize the front end portion of the main slider.

4. The disc loading device of claim 3, wherein the front end portion of the main slider operates the rotational door to open and close the slot.

5. The disc loading device of claim 1, further comprising a power train system comprising a plurality of gears disposed between the loading motor and the loading roller.

6. The disc loading device of claim 5, further comprising a power controlling device installed in the power train system and managing a power transferring path toward the loading roller.

7. The disc loading device of claim 6, wherein the power controlling device comprises:
a clutch gear disposed between gears of the power train system; and
a clutch lever for operating the clutch gear in synchronization with loading of the disc to block a power transferring path between the gears.

8. The disc loading device of claim 1, wherein, in response to the disc being loaded into the disc loading device, the rotational door rotates to cover the slot such that an interior of the disc loading device is not exposed to external elements.

9. A disc loading device comprising:
a main frame coupled to a front panel in which a slot is formed, wherein a disc is inserted into the slot;
an optical pickup assembly disposed in the main frame and comprising a spindle on which a disc is mounted and an optical pickup module to read data from the disc;
a loading roller configured to load the disc into the main frame;
an eject lever configured to eject the disc;
a main slider configured to operate the eject lever; and
a loading motor configured to drive the loading roller and the main slider.

10. The disc loading device of claim 9, further comprising a rotational door which comprises:
a body for opening and closing the slot;
hinge portions positioned at opposite end portions of the body and rotatably supporting the body against the main frame; and
a pressurizing portion that is disposed at one side of the body and which interferes with the main slider to perform open and close operations of the body.

11. The disc loading device of claim 10, wherein a front end portion of the main slider faces the front panel, and
an emergency eject hole through which an emergency eject pin passes is installed in the front panel to pressurize the main slider.

12. The disc loading device of claim 11, wherein the front end portion of the main slider operates the rotational door to open and close the slot.

13. The disc loading device of claim 9, further comprising a power train system comprising a plurality of gears disposed between the loading motor and the loading roller.

14. The disc loading device of claim 13, further comprising a power controlling device installed in the power train system and managing a power transferring path toward the loading roller.

15. The disc loading device of claim 14, wherein the power controlling device comprises:
a clutch gear disposed between gears of the power train system; and
a clutch lever for operating the clutch gear in synchronization with loading of the disc to block a power transferring path between the gears.

16. The disc loading device of claim 9, wherein, in response to the disc being loaded into the disc loading device, the rotational door rotates to cover the slot such that an interior of the disc loading device is not exposed to external elements.
